(19) United States
(12) Patent Application Publication
(10) Pub. No.: US 2014/0086551 A1
(43) Pub. Date: Mar. 27, 2014

(54) INFORMATION PROCESSING APPARATUS AND INFORMATION PROCESSING METHOD

(71) Applicant: CANON KABUSHIKI KAISHA, Tokyo (JP)

(72) Inventor: Kazue Kaneko, Kawasaki-shi (JP)

(73) Assignee: CANON KABUSHIKI KAISHA, Tokyo (JP)

(21) Appl. No.: 14/024,969

(22) Filed: Sep. 12, 2013

(30) Foreign Application Priority Data
Sep. 26, 2012 (JP) 2012-212966
Jul. 1, 2013 (JP) 2013-138442

(51) Int. Cl. H04N 9/87

(52) U.S. Cl. CPC H04N 9/87
USPC 386/230

(57) ABSTRACT

From a plurality of images acquired by capturing images from a plurality of viewpoints, a first image having a region at a first in-focus depth, a second image having a region at a second in-focus depth, which is different from the first in-focus depth, and a third image having a region at an in-focus depth between the first in-focus depth and the second in-focus depth are generated. The first image, the third image, and the second image are displayed on a display unit. A sound is generated from a sound associated with the first image and that associated with the second image. The generated sound is reproduced while the first image, the third image, and the second image are displayed on the display unit one by one.

### BACKGROUND OF THE INVENTION

1. Field of the Invention

The present invention relates to an information processing technique using refocus processing.

2. Description of the Related Art

Conventionally, a method of deciding a focus of a video at an image sensing timing and recording that video has been adopted. In recent years, a method of sensing multi-view videos using a plurality of lenses, and capable of changing a focus at a reproduction timing has been proposed. Using this method, depth changing processes from a state in which a certain point is in focus to a state in which an arbitrary point is in focus can be reproduced step by step. In an intermediate process, an out-of-focus video may be displayed.

On the other hand, a method of recording multi-listening sound data using a plurality of microphones, and reproducing a sound in a given direction while emphasizing it at a reproduction timing has also been proposed. Patent literature 1 (Japanese Patent Laid-Open No. 9-55925) has proposed a technique in which a plurality of cameras and a plurality of microphones are arranged in a circular pattern to capture videos through 360°, and a sound corresponding to a direction of a screen selected by the user is reproduced. Patent literature 2 (Japanese Patent Laid-Open No. 2011-50009) has proposed a technique in which a video is analyzed to detect a principal object region, and a sound is synthesized in correspondence with position information of that region. Also, a technique which synthesizes a sound according to video features has also been proposed. Patent literature 3 (Japanese Patent Laid-Open No. 7-131770) has proposed a technique in which a video is analyzed, and signal characteristics of an acoustic signal are changed in correspondence with features of the video.

Digital refocus processing suffers a problem about how to reproduce a sound. Upon shifting from a video which is in focus at a spot A to that which is in focus at a spot B, an out-of-focus video is often reproduced while gradually changing a depth of an in-focus position. Normally, the same sound is always reproduced. However, in order to enhance the presence, a sound source separation technique may be applied. It is desirable that when the spot A is in focus, a sound audible from the spot A is reproduced, and when the spot B is in focus, a sound audible from the spot B is reproduced. However, how to reproduce a sound of an out-of-focus video between these spots has not been examined yet.

From analogy from the method of patent literatures 1 and 2, since a direction and region cannot be settled for an out-of-focus video, indices of sounds to be synthesized cannot be obtained. Upon application of the method of patent literature 3, a fuzzy sound is reproduced for an out-of-focus image. However, fuzzy sounds are uniformly reproduced for videos of every processes, and step-by-step changes cannot be expressed.

### SUMMARY OF THE INVENTION

The present invention has been made in consideration of the above problems, and provides a technique which reproduces vivid sounds by changing a sound to be reproduced in correspondence with a change in focus of an image to be displayed.

According to one aspect of the present invention, there is provided an information processing apparatus comprising: an image generation unit configured to generate, from a plurality of images acquired by capturing images from a plurality of viewpoints, a first image having a region at a first in-focus depth, a second image having a region at a second in-focus depth, which is different from the first in-focus depth, and a third image having a region at an in-focus depth between the first in-focus depth and the second in-focus depth; a display control unit configured to display the first image, the third image, and the second image on a display unit; a sound generation unit configured to generate a sound from a sound associated with the first image and a sound associated with the second image; and a reproduction unit configured to reproduce the sound generated by the sound generation unit, wherein the reproduction unit reproduces the sound generated by the sound generation unit while the first image, the third image, and the second image are displayed on the display unit one by one.

According to another aspect of the present invention, there is provided an information processing apparatus comprising: an image generation unit configured to generate a plurality of images having regions at different in-focus depths from a plurality of images acquired by capturing images from a plurality of viewpoints; a separation unit configured to separate sounds collected using a plurality of sound collecting units, and to calculate sound source positions of respective separated sounds; and a registration unit configured to register, for each of the images generated by the image generation unit, a position of an object at the in-focus depth in that image and a sound of a sound source position related to that position in a holding unit in association with each other.

According to still another aspect of the present invention, there is provided an information processing method executed by an information processing apparatus, comprising: an image generation step of generating, from a plurality of images acquired by capturing images from a plurality of viewpoints, a first image having a region at a first in-focus depth, a second image having a region at a second in-focus depth, which is different from the first in-focus depth, and a third image having a region at an in-focus depth between the first in-focus depth and the second in-focus depth; a display control step of displaying the first image, the third image, and the second image on a display unit; a sound generation step of generating a sound from a sound associated with the first image and a sound associated with the second image; and a reproduction step of reproducing the sound generated in the sound generation step, wherein in the reproduction step, the sound generated in the sound generation step is reproduced while the first image, the third image, and the second image are displayed on the display unit one by one.

According to yet another aspect of the present invention, there is provided an information processing method executed by an information processing apparatus, comprising: an image generation step of generating a plurality of images having regions at different in-focus depths from a plurality of images acquired by capturing images from a plurality of viewpoints; a separation step of separating sounds collected using a plurality of sound collecting units, and of calculating sound source positions of respective separated sounds; and a registration step of registering, for each of the images generated in the image generation step, a position of an object at the in-focus depth in that image and a sound of a sound source position related to that position in a holding unit in association with each other.

Further features of the present invention will become apparent from the following description of exemplary embodiments with reference to the attached drawings.

### BRIEF DESCRIPTION OF THE DRAWINGS

FIGS. 1A to 1C are views showing an example of the outer appearance of an image sensing device;

FIG. 2 is a block diagram showing an example of the hardware arrangement of the image sensing device;

FIG. 3 is a block diagram showing an example of the functional arrangement of the image sensing device;

FIG. 4 is a flowchart of processing to be executed by the image sensing device;

FIG. 5A is a view for explaining an example of a sensed image, refocus images, and sounds;

FIG. 5B is a view for explaining sound source separation processing;

FIG. 5C is a view showing an example of a result of refocus processing;

FIG. 5D is a view showing an example of correspondence information;

FIG. 6 is a block diagram showing an example of the functional arrangement of an information processing apparatus;

FIG. 7 is a flowchart of processing to be executed by the information processing apparatus;

FIG. 8 is a view showing images to be displayed and sounds to be reproduced;

FIGS. 9A and 9B are views for explaining the operation according to the fourth embodiment;

FIGS. 10A and 10B are views for explaining the operation according to the fifth embodiment;

FIGS. 11A and 11B are views for explaining the operation according to the sixth embodiment;

FIGS. 12A to 12C are views for explaining the operation according to the sixth embodiment;

FIG. 13 is a block diagram showing an example of the functional arrangement of an information processing apparatus;

FIG. 14 is a flowchart of image reproduction processing and sound reproduction processing to be executed by the information processing apparatus; and

FIG. 15 is a flowchart of processes to be executed in steps S709 and S710.

### DESCRIPTION OF THE EMBODIMENTS

Embodiments of the present invention will be described hereinafter with reference to the accompanying drawings. Note that an embodiment to be described below represents an example when the present invention is carried out practically, and is one of practical embodiments of the arrangement described in the scope of the claims.

### First Embodiment

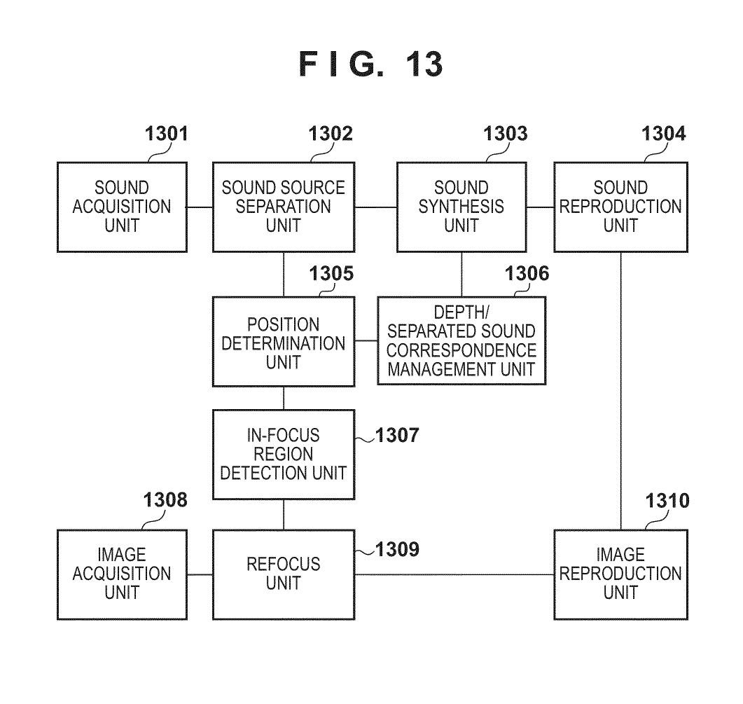

An example of the functional arrangement of an information processing apparatus according to this embodiment will be described below with reference to the block diagram of FIG. 13.

A sound acquisition unit 1301 acquires sounds (collected sounds) collected by a plurality of devices (microphones or the like) which can collect sounds. A sound source separation unit 1302 separates the collected sounds acquired by the sound acquisition unit 1301 into sounds from identical sound sources (separated sounds), and calculates positions of sound sources of the separated sounds.

A sound synthesis unit 1303 outputs sound data as data of a sound corresponding to an image to be reproduced and displayed by an image reproduction unit 1310. A sound reproduction unit 1304 outputs a sound based on the sound data output from the sound synthesis unit 1303 via a loudspeaker or the like. Sound reproduction processing of the sound reproduction unit 1304 is executed in synchronism with image reproduction processing by the image reproduction unit 1310.

An image acquisition unit 1308 acquires multi-view videos captured using a plurality of image sensing devices. A refocus unit 1309 executes refocus processing using the multi-view videos acquired by the image acquisition unit 1308, thereby generating a plurality of images (refocus images) respectively having different focus depths.

The image reproduction unit 1310 displays the refocus images generated by the refocus unit 1309 as display images. In this case, all the generated refocus images may be displayed at the same time or sequentially, or a refocus image designated by the user via an instruction unit (not shown) may be displayed. In either case, as described above, the sound reproduction unit 1304 reproduces a sound corresponding to a refocus image in synchronism with the image reproduction processing of the refocus image by the image reproduction unit 1310.

An in-focus region detection unit 1307 executes processing for detecting an in-focus region in each of the refocus images (display images) generated by the refocus unit 1309. Then, when the in-focus region detection unit 1307 can successfully detect an in-focus region from a refocus image, it calculates a position (in-focus position) of an object included in the in-focus region on a real space.

A position determination unit 1305 compares in-focus positions calculated by the in-focus region detection unit 1307 and sound source positions calculated by the sound source separation unit 1302, thereby searching for the sound source positions at the same positions as the in-focus positions. Note that “the same” in this case is not limited to “exactly the same”, but it is “the same after permission of errors in a certain allowable range”.

A depth/separated sound correspondence management unit 1306 executes processing for associating refocus images from which in-focus regions are calculated, and sounds from sound sources at the same positions as the in-focus positions with each other. In this embodiment, in-focus positions and sounds from sound sources at the same positions as the in-focus positions are registered in association with each other.

Note that various kinds of information may be registered. However, any kinds of information may be registered as long as respective processes to be described below can be implemented. The same applies to the following embodiments.

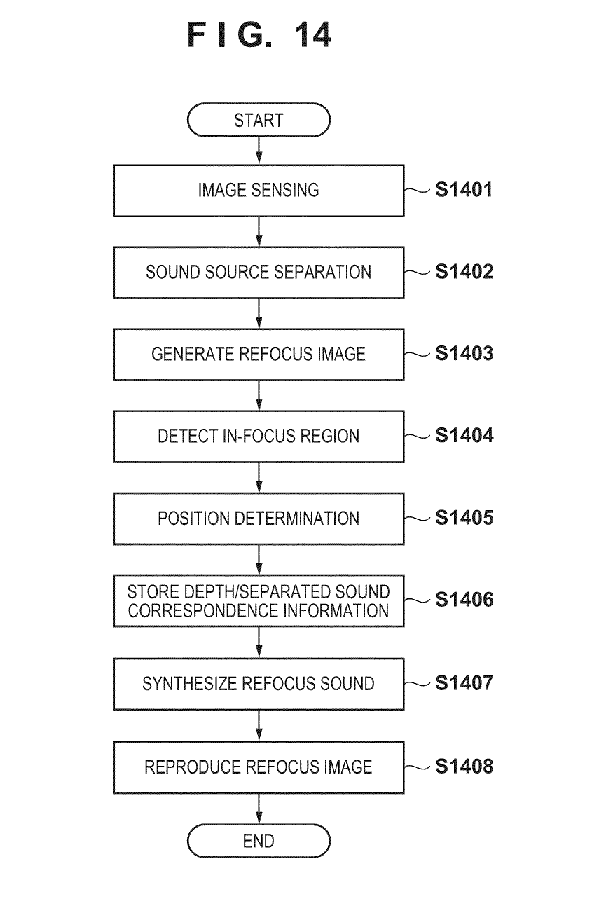

Image reproduction processing and sound reproduction processing to be executed by the information processing apparatus according to this embodiment will be described below with reference to the flowchart of FIG. 14.

In step S1401, since the plurality of image sensing devices sense moving images to capture multi-view videos, the image acquisition unit 1308 acquires the multi-view videos captured by the plurality of image sensing devices.

In step S1402, the sound source separation unit 1302 separates collected sounds acquired by the sound acquisition unit 1301 into separated sounds as sounds from identical sound sources, and calculates sound source positions of the separated sounds.

In step S1403, the refocus unit 1309 executes refocus processing using the multi-view videos acquired by the image acquisition unit 1308, thus generating a plurality of refocus images.

In step S1404, the in-focus region detection unit 1307 applies in-focus region detection processing to each of the refocus images generated by the refocus unit 1309. If an in-focus region is detected, the in-focus region detection unit 1307 calculates an in-focus position in that in-focus region.

In step S1405, the position determination unit 1305 respectively compares the in-focus positions calculated by the in-focus region detection unit 1307 and the sound source positions calculated by the sound source separation unit 1302, thus searching for the sound source positions at the same positions as the in-focus positions. In step S1406, the depth/separated sound correspondence management unit 1306 registers the in-focus positions and sounds from the sound sources at the same positions as the in-focus positions in association with each other.

In step S1407, if the in-focus position is calculated from the refocus image to be reproduced and displayed by the image reproduction unit 1310, and a sound is registered in association with that position, the sound synthesis unit 1303 outputs data of that sound to the sound reproduction unit 1304. On the other hand, if the in-focus position is calculated from the refocus image to be reproduced and displayed, but no sound is registered in association with that position, the sound synthesis unit 1303 generates a synthetic sound by synthesizing sounds registered in association with neighboring positions (adjacent positions) of that position. Then, the sound synthesis unit 1303 outputs data of this generated synthetic sound to the sound reproduction unit 1304. The sound reproduction unit 1304 reproduces a sound according to the data output form the sound synthesis unit 1303.

In step S1408, the image reproduction unit 1310 reproduces and displays the refocus image to be reproduced and displayed in synchronism with the sound reproduced by the sound reproduction unit 1304. Note that details of the processes in the respective steps in the flowchart shown in FIG. 14 will be described in the following embodiments, and a description thereof will not be given in this embodiment.

Note that the processes of steps S1402 to S1406 may be executed at arbitrary timings as long as they are executed after image sensing operations until digital refocus/reproduction processing. Also, the three processing sequence, that is, the processing sequence of step S1401, that of steps S1402 to S1406, and that of steps S1407 and S1408 can be divided as independent processing sequences.

### Second Embodiment

An information processing apparatus according to this embodiment is an image sensing device which includes a plurality of image sensing units and a plurality of sound collecting units to capture multi-view videos and to collect a plurality of sounds, and reproduces a corresponding sound in synchronism with reproduction/display processing of a refocus image.

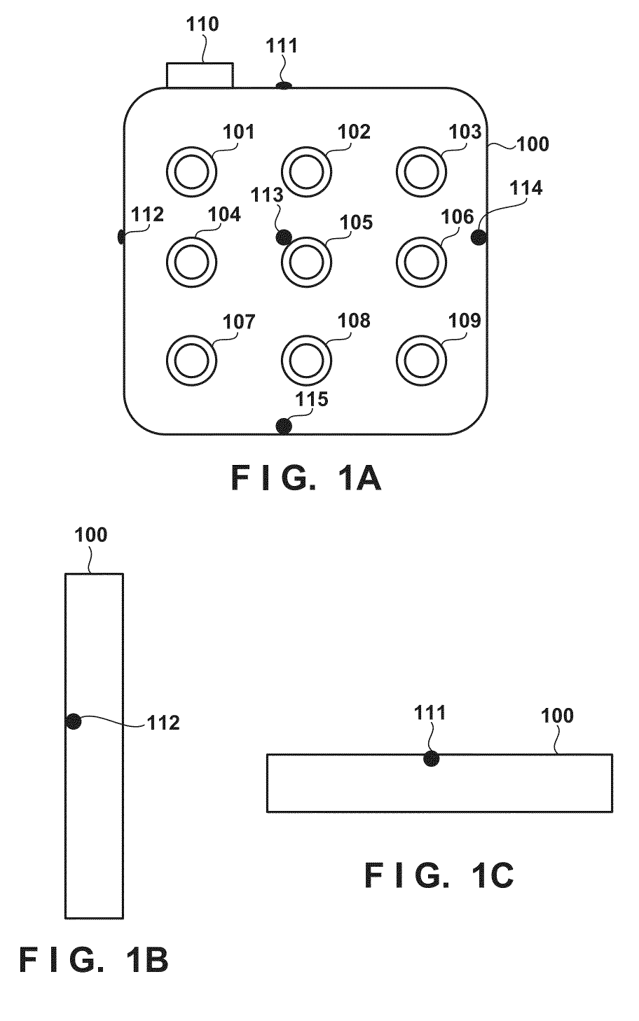

An example of the outer appearance of the image sensing device according to this embodiment will be described below with reference to FIGS. 1A to 1C. FIG. 1A is a front view of the image sensing device, FIG. 1B is a right side view of the image sensing device, and FIG. 1C is a top view of the image sensing device.

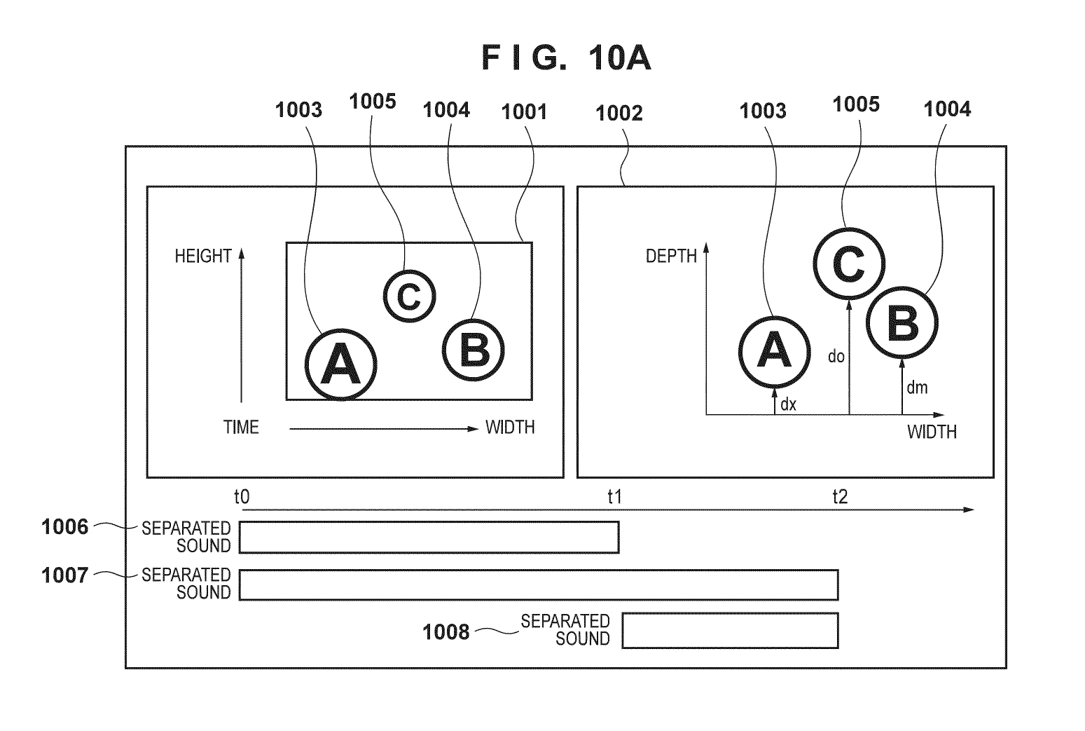

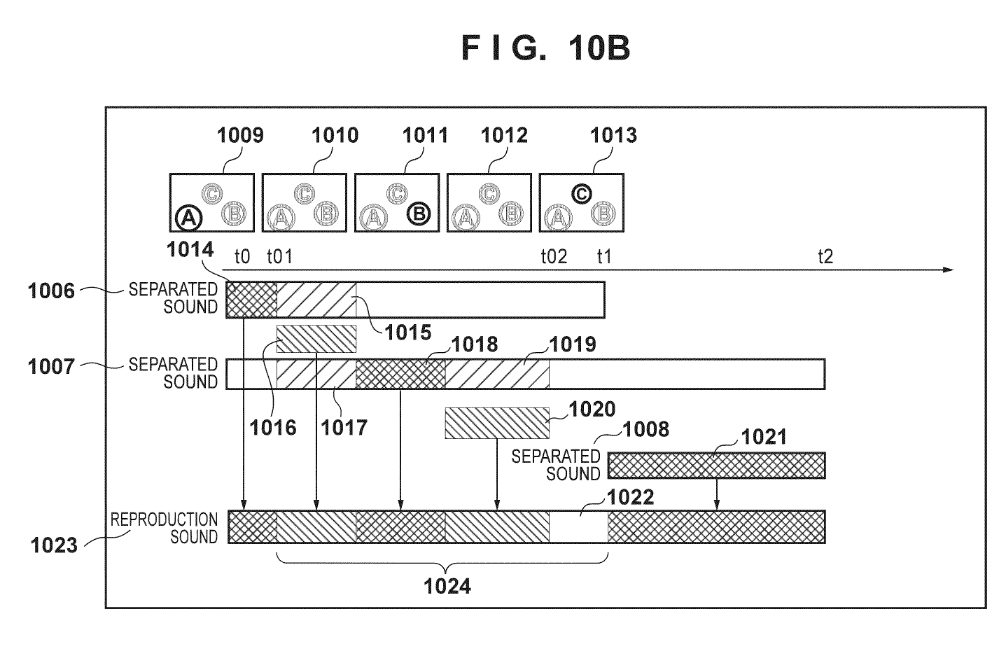

On a front surface of a main body 100 of the image sensing device, nine image sensing units 101 to 109 which can sense color images and three sound input units 113 to 115 having microphones which can collect sounds are arranged, as shown in FIG. 1A. One sound input unit 112 is arranged on a side surface of the image sensing device, as shown in FIGS. 1A and 1B, and one sound input unit 111 is arranged on the top surface of the image sensing device, as shown in FIGS. 1A and 10. Note that the numbers of image sensing units and sound input units and their layout patterns shown in FIGS. 1A to 10 are merely an example, and various modifications thereof are available. For example, the image sensing units may be laid out radially or linearly, or may be laid out at random positions. The same applies to the sound input units.

When the user presses an image sensing button 110, the image sensing units 101 to 109 and sound input units 111 to 115 are activated. Each of the image sensing units 101 to 109 converts, using own sensor (image sensor), light coming from an external world into an electric signal, and A/D-converts the electric signal to obtain a sensed image as digital data. Each of the sound input units 111 to 115 collects a sound from an external world, and A/D-converts the sound to obtain a sound as digital data.

The image sensing device with such system can obtain a color image group obtained by capturing a single object from a plurality of viewpoint positions and a sound group obtained by collecting and recording sounds generated around an image sensing position at a plurality of positions.

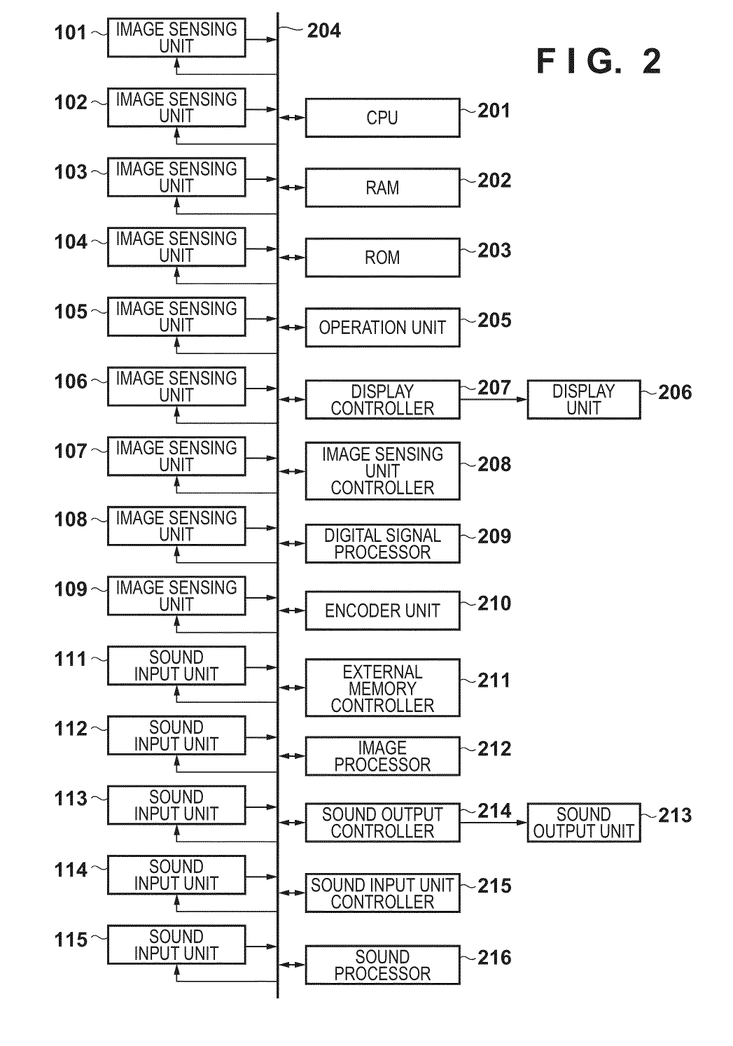

An example of the hardware arrangement of the image sensing device according to this embodiment will be described below with reference to the block diagram of FIG. 2. Note that the same reference numerals in FIG. 2 denote the same function units as those shown in FIGS. 1A to 1C, and a description thereof will not be repeated.

A CPU 201 controls operations of respective units included in the image sensing device by executing processing using computer programs and data stored in a RAM 202 and ROM 203, thereby implementing respective processes to be described later as those to be executed by the image sensing device.

The RAM 202 has areas used to temporarily store data obtained from the image sensing units 101 to 109 and sound input units 111 to 115. Furthermore, the RAM 202 has work areas used when respective units, that is, the CPU 201, a digital signal processor 209, an encoder unit 210, an image processor 212, a sound processor 216, and the like operate. That is, the RAM 202 can provide various areas as needed.

The ROM 203 stores various computer programs and data related to the operations of the image sensing device.

An operation unit 205 is operated by the user to input various instructions to the CPU 201, and includes buttons, a mode dial, and the like.

A display controller 207 executes display control required to display images and characters on a display unit 206. The display unit 206 is used to display images, characters, and the like, and adopts, for example, a liquid crystal display. Note that the display unit 206 may have a touch screen function. In this case, a user instruction using the touch screen can be handled as that of the operation unit 205.

An image sensing unit controller 208 executes operation control of the image sensing units 101 to 109, and controls opening/closing operations of shutters, adjustments of apertures, and the like of the image sensing units 101 to 109 in accordance with a control signal from the CPU 201.

The digital signal processor 209 executes processing appropriate for input data, that is, white balance processing, gamma processing, noise reduction processing, and the like. The encoder unit 210 executes processing for converting input data into a file format such as JPEG or MPEG.

An external memory controller 211 functions as an interface required to connect the image sensing device to a PC (personal computer) or other media (for example, a hard disk, memory card, CF card, SD card, and USB memory).

The image processor 212 executes image processing for generating refocus images and the like using sensed images of the image sensing units 101 to 109 and those processed by the digital signal processor 209.

A sound output controller 214 generates sound data to be supplied to a sound output unit 213, and executes operation control of the sound output unit 213. The sound output unit 213 operates under the control of the sound output controller 214. For example, the sound output unit 213 outputs a sound according to sound data supplied from the sound output controller 214 via a built-in loudspeaker, or externally outputs that sound via an external sound output terminal.

A sound input unit controller 215 controls to output sounds from the sound input units 111 to 115 to the RAM 202 as data, to switch silence/sound, microphone sensitivities of the sound input units 111 to 115 based on an instruction from the CPU 201, and so forth.

The sound processor 216 executes processing such as sound source separation processing, sound synthesis processing upon reproduction of a refocus image, and the like using sounds from the sound input units 111 to 115 and those obtained by processing these sounds by the digital signal processor 209.

The aforementioned units are connected to a bus 204. Note that principal units are merely enumerated as those shown in FIG. 2, and various modifications are available as long as respective processes to be described below can be achieved. For example, the encoder unit 210, image processor 212, and sound processor 216 may be implemented by computer programs, and may be stored in the ROM 203.

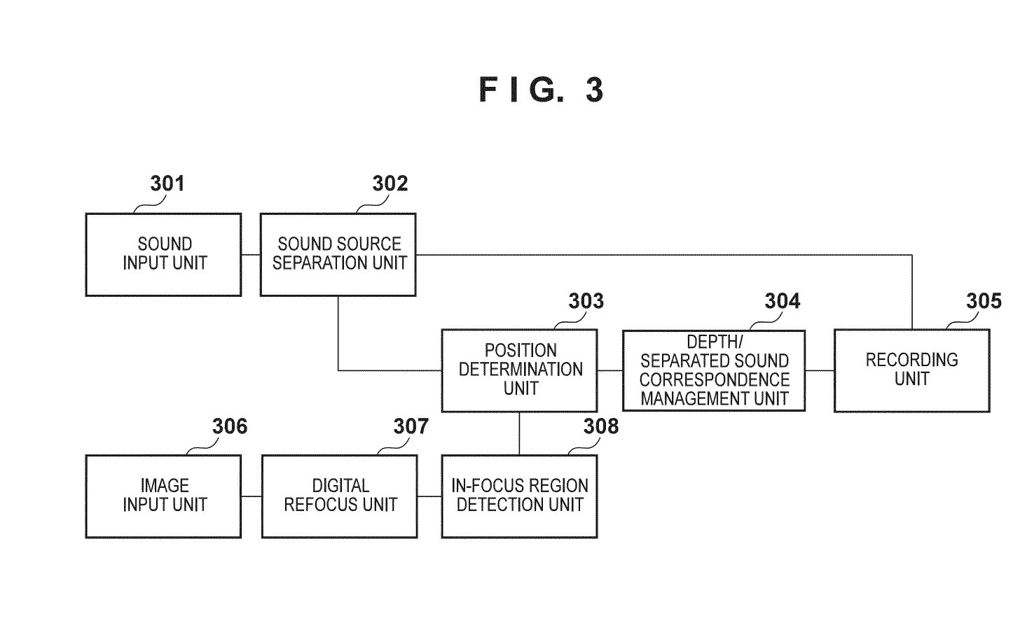

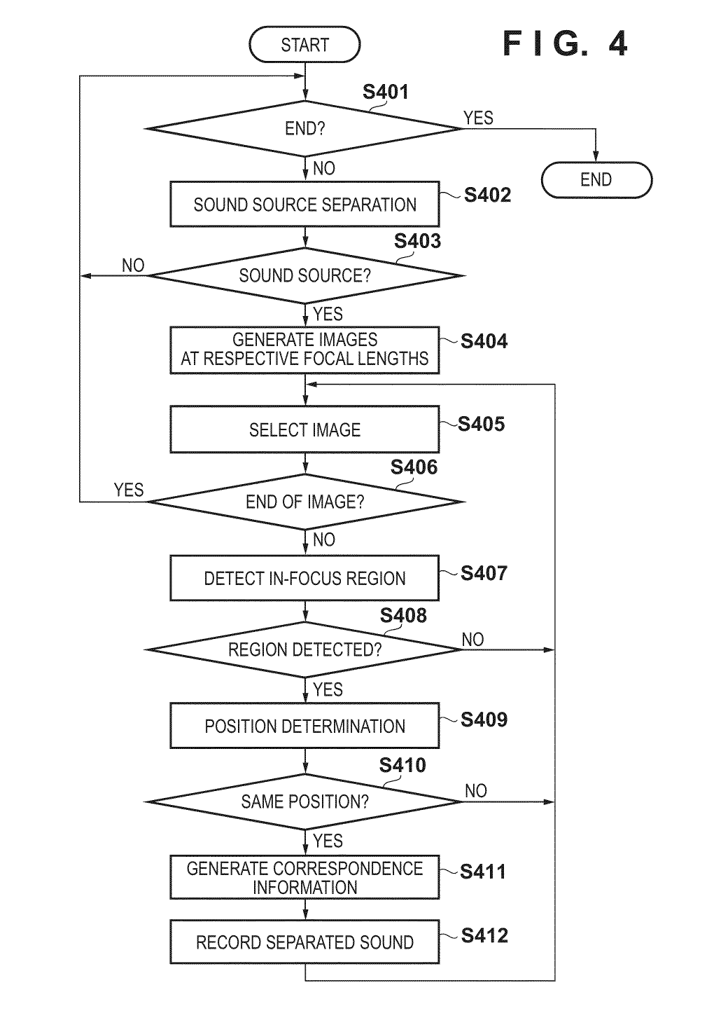

An example of the functional arrangement of the image sensing device according to this embodiment will be described below with reference to the block diagram of FIG. 3.

A sound input unit 301 acquires sounds (collected sounds) collected by the sound input units 111 to 115. The sound input unit 301 is implemented as the functions of the sound input unit controller 215 and digital signal processor 209.

A sound source separation unit 302 separates the collected sounds input by the sound input unit 301 into sounds from identical sound sources (separated sounds), and calculates positions of sound sources of the separated sounds. The sound source separation unit 302 is implemented as the function of the sound processor 216.

An image input unit 306 acquires multi-view videos captured using the image sensing units 101 to 109. The image input unit 306 is implemented as the functions of the image processor 212 and digital signal processor 209.

A digital refocus unit 307 executes refocus processing using the multi-view videos input by the image input unit 306 to generate a plurality of images (refocus images) which have a given depth of field and arbitrary in-focus depths. The digital refocus unit 307 is implemented as the function of the image processor 212.

An in-focus region detection unit 308 executes processing for detecting, as an in-focus region, a region where an object is in focus in each of the refocus images generated by the digital refocus unit 307. Then, when the in-focus region detection unit 308 detects an in-focus region in a refocus image, it calculates an in-focus position in the in-focus region on a real space. The in-focus region detection unit 308 is implemented as the function of the image processor 212.

A position determination unit 303 compares the in-focus positions calculated by the in-focus detection unit 308 and the positions of the sound sources calculated by the sound source separation unit 302 to search for the positions of the sound sources at the same positions as the in-focus positions. The position determination unit 303 is implemented as the function of the CPU 201.

A depth/separated sound correspondence management unit 304 associates refocus images from which in-focus regions are calculated and sounds from sound sources at the same positions as the in-focus positions in the in-focus region with each other. In this embodiment, the in-focus positions and the sounds from the sound sources at the same positions as the in-focus positions are associated with each other. The depth/separated sound correspondence management unit 304 is implemented as the function of the CPU 201.

A recording unit 305 executes processing for recording information associated by the depth/separated sound correspondence management unit 304 in a memory or the like, and is implemented as the function of the external memory controller 211.

Note that when this processing is applied to video data recorded in an external memory or those transferred from an external device, the present invention is not limited to the arrangement of the image sensing device shown in FIG. 2, and processing can be executed on a PC. The sound input unit 301 and image input unit 306 are those of sounds and images.

Processing to be executed by the image sensing device to execute sound source separation processing and digital refocus processing and to associate in-focus depths with separated sounds upon execution of the digital refocus processing will be described below with reference to FIG. 4 which shows the flowchart of that processing. Assume that multi-view videos (which may have been processed by the digital signal processor 209) from the image sensing units 101 to 109 have already been stored in the RAM 202 at the beginning of the processing according to the flowchart of FIG. 4.

The CPU 201 judges in step S401 whether or not the RAM 202 stores data to be processed. If the CPU 201 judges that the RAM 202 stores data to be processed, the process advances to step S402; otherwise, the processing according to the flowchart of FIG. 4 ends. The following processing is repeated for target videos at a predetermined time interval (for example, at a 100-msec interval). When the processing is to be applied to videos which are being sensed, the processing starts at the beginning of the image sensing operation, and ends after the end of the image sensing operation.

In step S402, the sound processor 216 separates collected sounds (which may be processed by the digital signal processor 209) collected by the sound input units 111 to 115 within a predetermined period into sounds (separated sounds) from identical sound sources, and calculates positions of sound sources of the separated sounds.

Note that as a sound source separation method for separating collected sounds into sounds (separated sounds) from identical sound sources, a blind sound source separation method based on independent component analysis or the like can be used, but since it is a known technique, a description thereof will not be given. As the sound source separation result, sounds generated from different sound sources can be divisionally extracted. Also, a method of estimating and using an arrival time difference of respective sound sources to a pair of microphones upon clustering signals separated for respective frequencies can also be used. In this case, a position of a sound source can be extracted using triangulation based on the microphone position information and arrival time difference (sound localization).

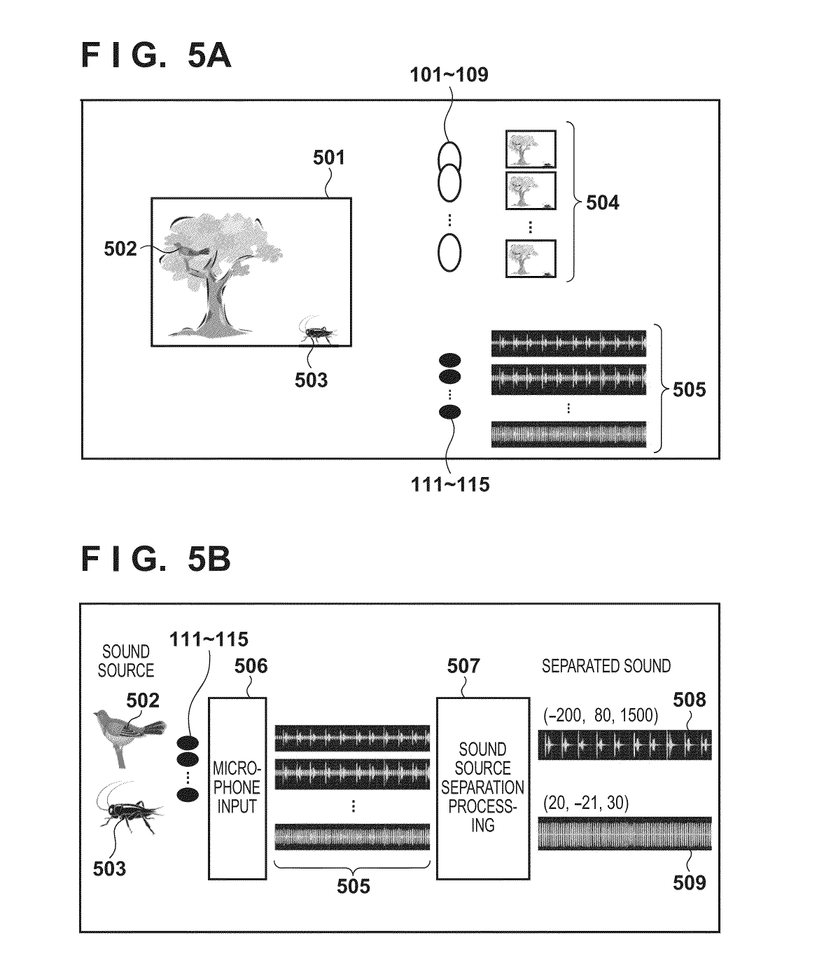

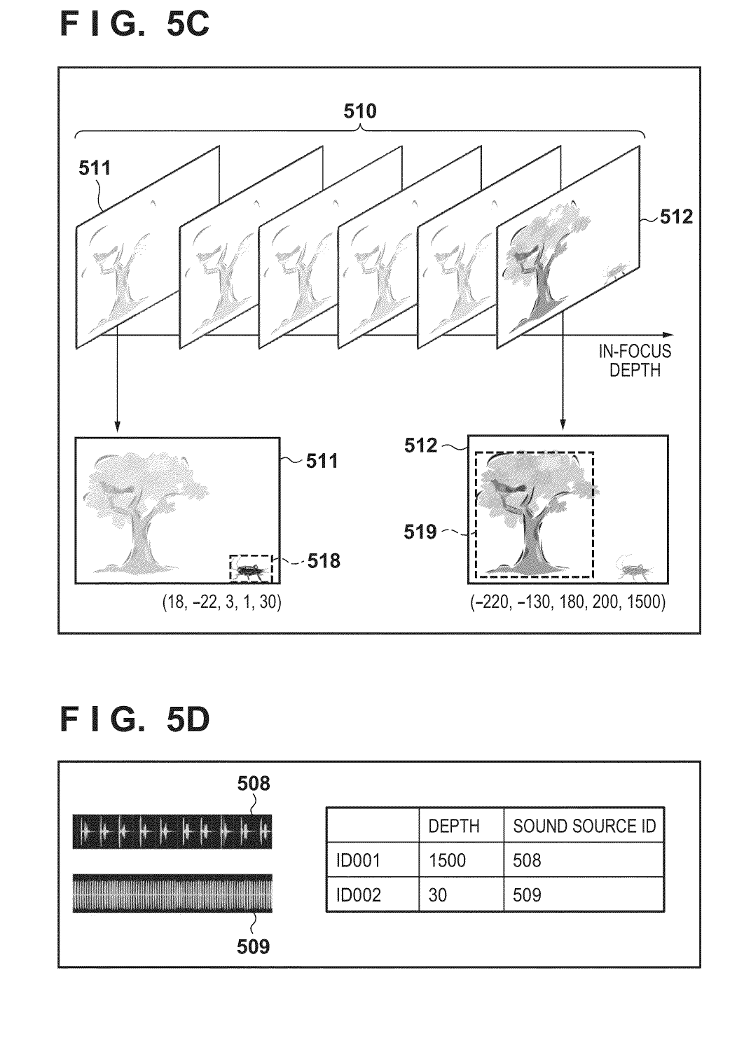

In an image sensing example shown in FIG. 5A, a video 501 of a scene in which a cricket 503 is present at a near distance, a cuckoo 502 on a tree is present at a far distance, and the cricket 503 and cuckoo 502 are singing at the same time is captured. By capturing such scene using the image sensing units 101 to 109, multi-view videos 504 are captured, and sounds 505 in this scene are recorded by the sound input units 111 to 115.

The sounds 505 obtained from the sound input units 111 to 115 (microphone inputs 506) are those in which singings of the cricket 503 and cuckoo 502 are mixed, but distributions of their volumes and sound arrival times are subtly different. By applying sound source separation processing 507 to the sounds 505, separated sounds 508 and 509 can be obtained. At this time, position information (sound source position (including a depth)) of each sound source is also calculated. Information (−200, 80, 1500) above the sound 508 in FIG. 5B represents a position of the separated cuckoo's sound, that is, an actual sound source position using (x, y, z) in cm units of a plain scale when the center of an image frame is defined by (0, 0). That is, this position information indicates that the sound is generated from a position which is distant from the central position by 2 m in the left direction and by 0.8 m in the up direction on a two-dimensional plane at a distance corresponding to a depth of 15 m. Also, information (20, −21, 30) above the sound 509 in FIG. 5B represents a position of separated cricket's sound. This information indicates that the sound is generated from a position which is distant from the central position by 0.20 m in the right direction and by 0.21 m in the down direction on a two-dimensional plane at a distance corresponding to a depth of 0.3 m.

Referring back to FIG. 4, the CPU 201 judges in step S403 whether or not the separated sounds can be calculated. When separated signals which are separated for respective frequency components are clustered using estimated arrival time differences, if significant clusters cannot be generated since signals do not group together within arbitrary ranges, sound sources cannot be separated (separated sounds cannot be calculated). If sound sources cannot be separated, the CPU 201 judges that videos in that time zone do not include any corresponding sound source, and the process returns to step S401. On the other hand, if sound sources can be separated (separated sounds can be calculated), the process advances to step S404.

In step S404, the image processor 212 executes refocus processing using the multi-view videos acquired by the image sensing units 101 to 109, thereby generating a plurality of images which have a given depth of field and arbitrary in-focus depths (refocus images) at arbitrary depth intervals. The intervals may be defined by a constant distance or those which are calculated using a logarithm that assures wider intervals in a front direction and narrower intervals in a depth direction.

As the refocus method, a synthetic aperture image sensing method for shifting or synthesizing each image from a plurality of images having different image sensing positions to generate refocus images is available. However, since that method is a known technique, a detailed description thereof will not be given. FIG. 5C is a view showing an example of the refocus processing result. Reference numeral 510 denotes a refocus image group generated by changing in-focus depths.

Referring back to FIG. 4, the CPU 201 selects one of refocus images to be selected of the plurality of refocus images generated in step S404 as a selected refocus image in step S405.

The CPU 201 judges in step S406 whether or not no refocus image to be selected remains and a refocus image to be selected cannot be selected in step S405. If the CPU 201 judges that a refocus image to be selected can be selected, the process advances to step S407; otherwise, the process returns to step S401.

In step S407, the image processor 212 applies image processing to the selected refocus image to execute detection processing of a region including an image having a low defocusing degree and sharp border (in-focus region). As a criterion used to determine a defocusing degree of an image, an MTF (Modulation Transfer Function) curve can be used. Since the MTF calculation method is a known technique, a detailed description thereof will not be given. An image is divided into given regions, MTF curves are calculated for the respective divided regions, and a region where spatial frequency components are present in given quantities in a high-frequency range is determined as an in-focus region. Referring to FIG. 5C, refocus images 511 and 512 are respectively images in which in focus regions are present. In the refocus image 511, a region 518 is focused. In the refocus image 512, a region 519 is focused.

Then, the image processor 212 calculates a position of an object included in an in-focus region on the real space as an in-focus position. An in-focus region is initially calculated as coordinates in pixel units in an image, but it is converted to a position of the plain scale which is indicated in an order of (x, y, width, height, z) in cm units by combining pieces of information of a field angle and the like, so as to further examine the identity with the sound source position. Information (−220, −130, 180, 200, 1500) below the region 519 in FIG. 5C indicates that objects (cuckoo and tree) included in a region which is distant from the center by 2.2 m in the left direction and by 1.3 m in the down direction with a width of 1.8 m and a height of 2 m on a two-dimensional plane at a distance corresponding to a depth of 15 m are in focus. Information (18, −22, 3, 1, 30) below the region 518 indicates that an object (cricket) included in a region which is distant from the center by 0.18 m in the right direction and by 0.22 m in the down direction with a width of 0.03 m and a height of 0.01 m on a two-dimensional plane at a distance corresponding to a depth of 0.3 m is in focus. Refocus images between these images are entirely out-of-focus images including no in-focus region.

Referring back to FIG. 4, the CPU 201 judges in step S408 whether or not an in-focus region is detected from the selected refocus image. If the CPU 201 judges that an in-focus region is detected from the selected refocus image, the process advances to step S409; otherwise, the process returns to step S405.

The CPU 201 judges in step S409 whether or not the sound source positions calculated in step S402 include the same position as that calculated in step S407. The region of the object (cricket) indicated by the information (18, −22, 3, 1, 30) of the region 518 in the refocus image 511 in FIG. 5C overlaps the sound source position of the separated sound 509. Therefore, in this case, the CPU 201 judges that the in-focus position in the region 518 in the refocus image 511 is the same position as the sound source position of the separated sound 509. Also, the region of the objects indicated by the information (−220, −130, 180, 200, 1500) of the region 519 in the refocus image 512 in FIG. 5C overlaps the sound source position of the separated sound 508. Therefore, in this case, the CPU 201 judges that the in-focus position in the region 519 in the refocus image 512 is the same position as the sound source position of the separated sound 508.

Note that in position determination, in place of overlapping of points, when the sound source position and in-focus position are laid out on each of regions obtained by two-dimensionally dividing the height and width of a frame into a plurality of regions and dividing the depth into a near distance region, middle distance region, and far distance region, if they are located on the same divided region, the CPU 201 may judge that they correspond to the same position. The number of divisions may be arbitrarily determined.

If the sound source positions calculated in step S402 include the same position as that calculated in step S407, the process advances to step S411 via step S410; otherwise, the process returns to step S405.

In step S411, the CPU 201 generates correspondence information as a set of the in-focus position (an in-focus depth coordinate in the in-focus region) and an ID assigned to the sound source at the same position as the in-focus region, as exemplified in FIG. 5D.

Then, in step S412, the external memory controller 211 records the correspondence information generated in step S411 in a memory connected to itself. Of course, a recording destination is not limited to a specific recording destination.

In this embodiment, in order to associate a refocus image and separated sound with each other, an in-focus position (depth) and a sound from a sound source at the same position as the in-focus position are associated with each other. As modifications, if there are a plurality of in-focus regions which are distant from each other, and there are also a plurality of corresponding separated sounds, a plurality of separated sounds corresponding to one depth may be synthesized to generate one-to-one correspondence information, or a plurality of separated sounds may be associated with one depth.

On the other hand, a separated sound position and in-focus position may be stored together. When there are a plurality of corresponding sound sources for videos including a plurality of in-focus regions which are distant from each other, information including a depth, in-focus position, separated sound position, and separated sound may be registered in the memory to associate a plurality of separated sounds with one depth.

In the above embodiment, the processes of steps S402 to S412 are repeated at predetermined time intervals. However, sound source separation processing at predetermined time intervals may be applied to all videos, after the sound source separation processing, digital refocus image generation processing and in-focus region detection processing at predetermined time intervals may be executed for all the videos, and generation processing of all pieces of correspondence information at predetermined time intervals may then be executed.

In either case, the arrangement of the apparatus described in this embodiment and other embodiments is merely an example of the following arrangement, and various modifications are made under the premise of the following arrangement.

That is, videos captured from a plurality of viewpoints are acquired as multi-view video, and refocus processing is executed using the multi-view videos, thus generating a plurality of images having different in-focus depths. Also, sounds collected at a plurality of positions are separated for respective sound sources, and positions of the sound sources on the real space are calculated. Then, a position of an in-focus object in each of the generated images and a sound from a sound source at the same position as that position are registered in association with each other.

### Third Embodiment

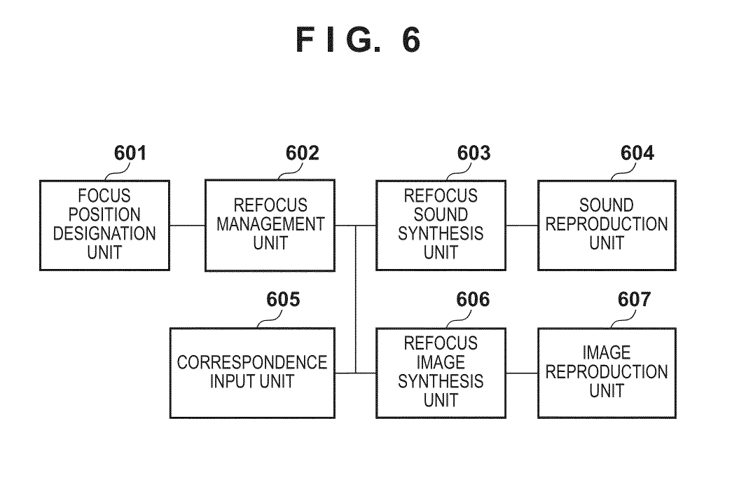

An example of the functional arrangement of an information processing apparatus which executes digital refocus processing during reproduction of a moving image will be described below with reference to the block diagram of FIG. 6.

A focus position designation unit 601 is used to designate an in-focus depth, and corresponds to the function of an operation unit 205. A refocus management unit 602 is used to manage digital refocus transition processes, and corresponds to the function of a CPU 201. A refocus sound synthesis unit 603 is used to generate a sound corresponding to a refocus image to be displayed by synthesis processing, and corresponds to the function of a sound processor 216. A sound reproduction unit 604 is used to output the sound generated by the refocus sound synthesis unit 603, and corresponds to the functions of a sound output unit 213 and sound output controller 214. A correspondence input unit 605 is used to acquire the aforementioned correspondence result. A refocus image synthesis unit 606 is used to generate a refocus image having an in-focus position corresponding to the designated depth, and corresponds to the function of an image processor 212. An image reproduction unit 607 is used to reproduce and display the refocus image generated by the refocus image synthesis unit 606, and corresponds to the functions of a display controller 207 and display unit 206.

Note that when this processing is applied to video data recorded in an external memory or those transferred from an external device, the present invention is not limited to the arrangement of the image sensing device shown in FIG. 2, and processing can be executed on a PC.

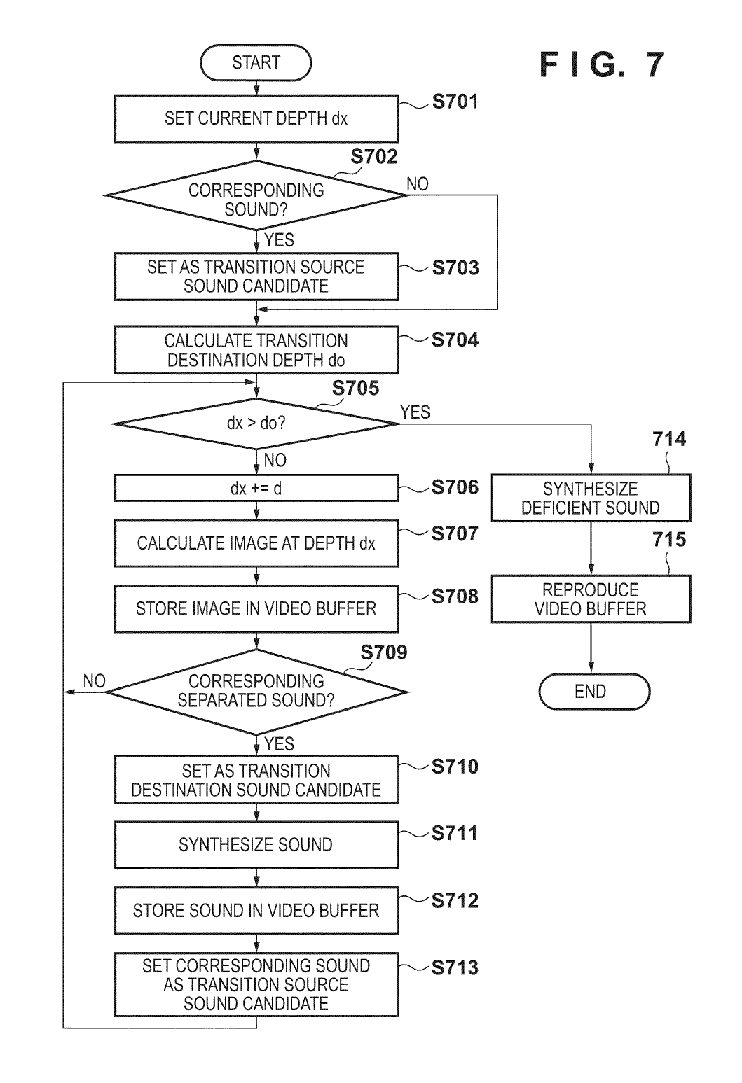

Processing required to execute digital refocus processing during reproduction of a moving image by the information processing apparatus having the arrangement shown in FIG. 6 will be described below with reference to FIG. 7 which shows the flowchart of that processing. The processing shown in FIG. 7 starts when a digital refocus instruction is input by a user operation during reproduction of a moving image. A depth of a focus transition destination used as a refocus end condition may be that of an object present at one spot on a display screen selected by the user on the screen when a refocus start instruction is input, or may be a moving amount of a depth designated by a slider or dial. When the designated depth is in the back of the current depth, refocus processing from the front side to the back side is executed; when the designated depth is in front of the current depth, refocus processing from the back side to the front side is executed.

A time period required for refocus processing is determined by a difference between the current depth and a depth as a change destination and a step-by-step depth shift speed (interval). This interval is set in advance, but it can be changed by the user.

Note that a reproduction time period of an in-focus video immediately before the refocus processing is not included in the digital refocus processing. However, when a moving image reproduction start instruction and digital refocus instruction are simultaneously issued, reproduction of an in-focus video immediately before the refocus processing for a predetermined time period may be included in the refocus processing.

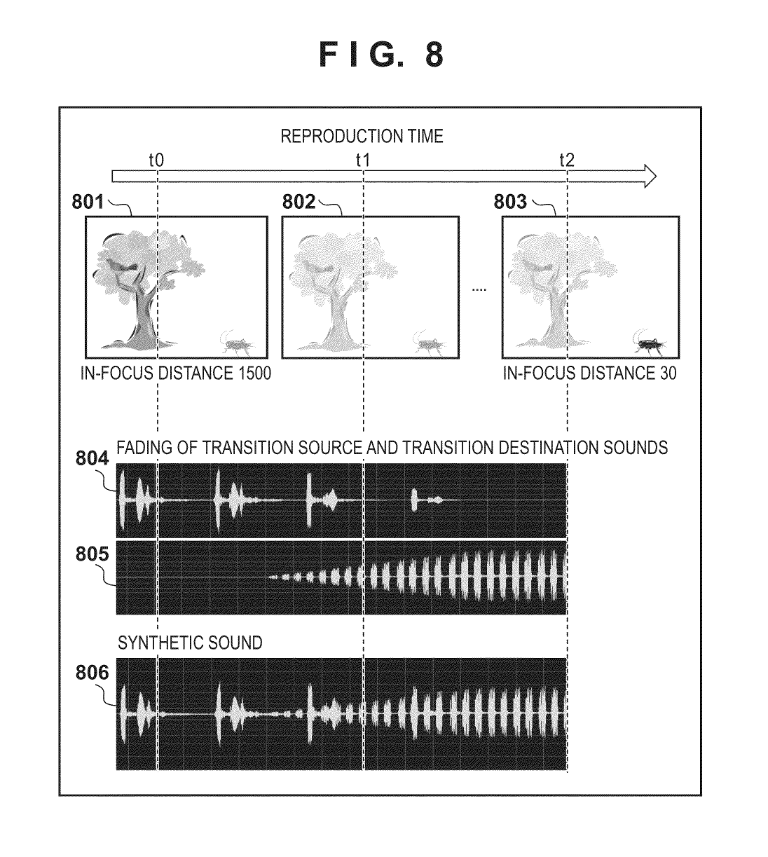

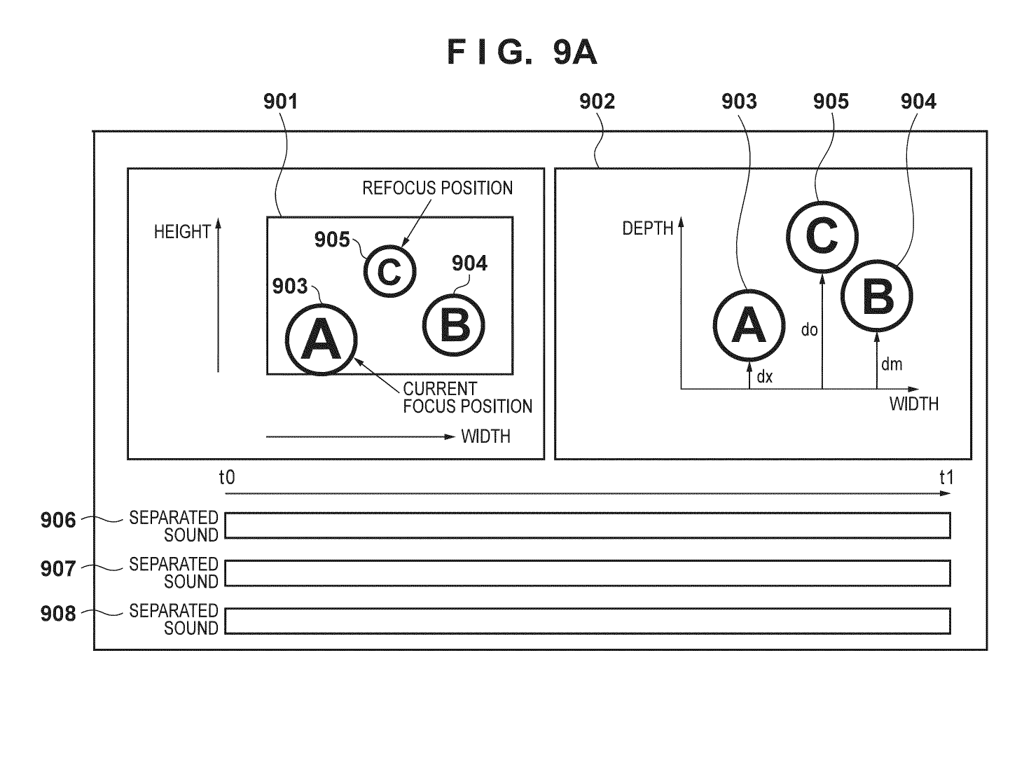

In step S701, the focus position designation unit 601 acquires an in-focus depth dx of an in-focus region in a currently displayed refocus image. In an example shown in FIG. 8, the in-focus depth dx of an in-focus region in a currently displayed refocus image 801 (which is being displayed at time t0) is 1500.

Next, the correspondence input unit 605 judges in step S702 whether or not a sound is registered in association with the depth dx acquired in step S701. If the correspondence input unit 605 judges that a sound is registered in association with the depth dx, the process advances to step S703; otherwise, the process jumps to step S704.

In step S703, the refocus sound synthesis unit 603 acquires the sound, which is registered in association with the depth dx acquired in step S701, as a transition source sound candidate from the correspondence input unit 605.

In step S704, the focus position designation unit 601 acquires a final in-focus depth do. Then, the refocus management unit 602 judges in step S705 whether or not dx<do if dx>do or whether or not dx>do if dx<do. In either case, the refocus management unit 602 judges whether or not the current depth dx has exceeded the final in-focus depth. If the refocus management unit 602 judges that the current depth dx does not exceed the final in-focus depth, the process advances to step S706; otherwise, the process advances to step S714. That is, processing immediately after a refocus destination object comes into focus until an elapse of a predetermined time period is the refocus processing.

In step S706, the refocus management unit 602 adds d as a prescribed value to dx. Note that if dx (acquired in step S701)>do, d assumes a negative value; if dx (acquired in step S701)<do, d assumes a positive value.

In step S707, the refocus image synthesis unit 606 generates a refocus image (next image to be displayed) having the in-focus depth dx by executing refocus processing using the multi-view videos. Then, in step S708, the refocus image synthesis unit 606 stores the generated refocus image in a buffer (video buffer: not shown).

The correspondence input unit 605 judges in step S709 whether or not a sound is registered in association with the in-focus depth dx. If the correspondence input unit 605 judges that a sound is registered in association with the depth dx, the process advances to step S710; otherwise, the process returns to step S705. In step S710, the refocus sound synthesis unit 603 acquires the sound, which is registered in association with the depth dx, from the correspondence input unit 605 as a transition destination sound candidate.

Then, in step S711, the refocus sound synthesis unit 603 generates a sound by synthesizing the sound of the transition source sound candidate and that of the transition destination sound candidate.

Note that as dx is closer to do, a synthesis distribution is adjusted so that the sound of the transition destination sound candidate is heard louder than the transition source sound candidate. Then, in step S712, the refocus sound synthesis unit 603 stores this generated sound in the buffer (video buffer: not shown).

In step S713, the refocus sound synthesis unit 603 sets the sound of the current transition destination sound candidate as that of a transition source sound candidate. Then, the process returns to step S705.

In step S714, the refocus sound synthesis unit 603 generates a deficient sound. When a video having the depth do includes an in-focus region, and a corresponding separated sound is registered, sounds are sufficiently generated. However, when a video does not include any in-focus region, or no corresponding separated sound is registered, a sound is deficient. If the transition source sound candidate is registered, a deficient sound is generated using that candidate; otherwise, silence is generated.

In step S715, the image reproduction unit 607 reads out and displays refocus images stored in the video buffer in a storage order, and the sound reproduction unit 604 reads out and reproduces sounds corresponding to the refocus image in synchronism with the refocus images to be displayed.

In the example of FIG. 8, a refocus image 801 having a depth=1500 is displayed at time t0, and an out-of-focus refocus image 802 having a depth dx at that time is displayed at time t1. Then, a refocus image 803 having a final in-focus depth=30 is displayed at time t2.

In the example of FIG. 8, assume that a separated sound 508 corresponding to the in-focus depth=1500, and a separated sound 509 corresponding to the in-focus depth=30 are registered, as shown in FIG. 5D (in FIG. 5D, IDs are registered, and corresponding sounds are also registered).

The separated sound 508 is reproduced at time t0. A sound 804 is reproduced while reducing a volume of the separated sound 508 from an original volume (or a slightly larger volume) to a value around zero along with the elapse of time. Also, a sound 805 is reproduced while raising a volume of the separated sound 509 from a value around zero to an original volume (or a slightly larger volume). Therefore, at respective times between times t0 and t2, a part corresponding to a given time is reproduced in a synthetic sound 806 of these sounds 804 and 805. For example, assuming that time t1 is an intermediate time between times t0 and t2, a synthetic sound of a sound obtained by halving the volume of the separated sound 508 and that obtained by halving the volume of the separated sound 509 is reproduced at time t1. Of course, even during a period between times t0 and t2, if a sound corresponding to an in-focus position is registered, that sound is reproduced.

When either the transition source sound candidate or transition destination sound candidate is not registered, the volume of only the registered sound candidate is changed step by step, and that sound is reproduced in a display time zone of an out-of-focus video.

In the flowchart of FIG. 7, images and sounds are stored before the current dx exceeds the final in-focus depth, and after the current dx exceeds the final in-focus depth, images and sounds are displayed/reproduced. Alternatively, when an image and sound are generated, they may be displayed/reproduced without being stored.

In the above embodiment, the transition destination in-focus depth is given in advance, and is used as an end condition. However, only either the front or back direction and step-by-step depth change speed (interval) may be given without giving any transition destination depth in advance at the beginning of processing, and an end condition may be a detection timing of a user's refocus end operation. In this case, storage of a read-ahead video to be reproduced in the video buffer and sequential reproduction of the stored video are repeated. In the generation method of a synthetic sound from the transition source sound candidate and transition destination sound candidate, addition of an echo and noise and the like may be made in addition to the step-by-step volume change.

### Fourth Embodiment

This embodiment will explain synthesis of sounds when an in-focus state is obtained at three points, that is, a transition source, intermediate point, and transition destination during refocus processing.

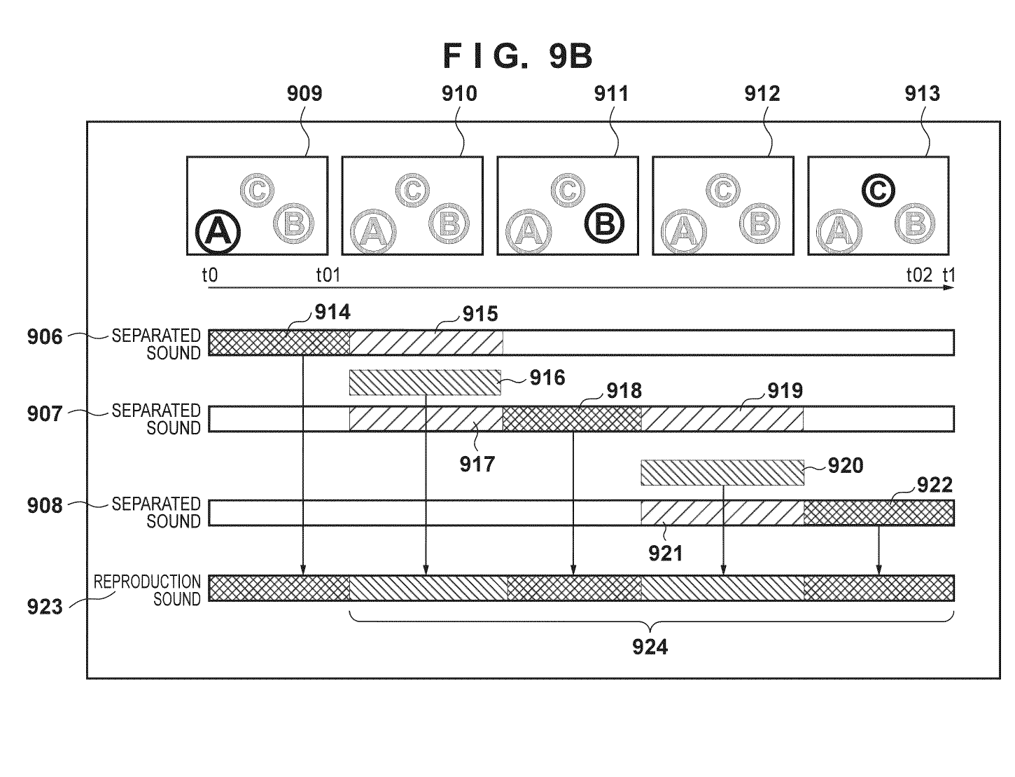

Referring to FIG. 9A, a sensed image 901 includes objects 903 to 905, and is captured while the object 903 of the objects 903 to 905 is in focus.

In a frame 902, the positional relationship of the objects 903 to 905 with respect to the width direction of the sensed image 901, and in-focus depths for the objects 903 to 905 are shown. In FIG. 9A, an in-focus depth for the object 903 is dx, that for the object 904 is dm, and that for the object 905 is do (dx<dm<do).

Also, in FIG. 9A, sounds are generated respectively from the objects 903 to 905 during a period from time t0 to time t1. The sounds respectively from the objects 903 to 905 are respectively obtained by the aforementioned sound source separation as a sound (separated sound) 906 from the object 903 as a sound source, a sound (separated sound) 907 from the object 904 as a sound source, and a sound (separated sound) 908 from the object 905 as a sound source.

As shown in FIG. 9B, a sensed image 909 including the in-focus object 903 is displayed during a period from time t0 to time t01. Then, during a period from time t01 to time t02, refocus images in which an in-focus target changes in an order of the objects 904 and 905 are generated and displayed.

Refocus images 910 to 913 are those generated during the period from time t01 to time t02, and are displayed every time they are generated. The refocus image 910 has an in-focus depth between that for the object 903 and that for the object 904, and does not include any in-focus object. The refocus image 911 has the in-focus depth for the object 904, and includes the in-focus object 904. The refocus image 912 has an in-focus depth between that for the object 904 and that for the object 905, and does not include any in-focus object. The refocus image 913 has the in-focus depth for the object 905, and includes the in-focus object 905.

As described above, the sensed image 909 including the in-focus object 903 is displayed during the period from time t0 to time t01. Therefore, a sound 914 during the period from time t0 to time t01 in the sound 906 from the object 903 as a sound source is reproduced as a reproduction sound 923 during the period from time t0 to time t01.

Also, during a display period of the refocus image 910, a sound 915 during the display period in the sound 906 from the object 903 as a sound source is set as a transition source sound candidate, and a sound 917 during the display period in the sound 907 from the object 904 as a sound source is set as a transition destination sound candidate. Then, a sound 916 obtained by synthesizing the transition source sound candidate and transition destination sound candidate by sequentially changing a volume distribution between the transition source sound candidate and transition destination sound candidate (the volumes of the transition source sound candidate and transition destination sound candidate become smaller/larger as the elapse of a time) is reproduced as the reproduction sound 923 during the display period.

The refocus image 911 includes the in-focus object 904. Therefore, a sound 918 during a display period of the refocus image 911 in the sound 907 from the object 904 as a sound source is reproduced as the reproduction sound 923 during the display period.

Also, during a display period of the refocus image 912, a sound 919 during the display period in the sound 907 from the object 904 as a sound source is set as a transition source sound candidate, and a sound 921 during the display period in the sound 908 from the object 905 as a sound source is set as a transition destination sound candidate. Then, a sound 920 obtained by synthesizing the transition source sound candidate and transition destination sound candidate by sequentially changing a volume distribution between the transition source sound candidate and transition destination sound candidate (the volumes of the transition source sound candidate and transition destination sound candidate become smaller/larger as the elapse of a time) is reproduced as the reproduction sound 923 during the display period.

The refocus image 913 includes the in-focus object 905. Therefore, a sound 922 during a display period of the refocus image 913 in the sound 908 from the object 905 as a sound source is reproduced as the reproduction sound 923 during the display period.

Note that generation of refocus images and settlement of the reproduction sound 923 require a certain time period. Depending on the number of refocus images to be generated, the volume of the reproduction sound 923, and the specification of the information processing apparatus, this time period is often long. In such case, a generated refocus image and reproduction sound may be temporarily stored in a buffer 924, and the sounds and videos accumulated in the buffer 924 may be synchronously output, as described above.

### Fifth Embodiment

This embodiment will explain synthesis of sounds when an in-focus state is obtained at three points, that is, a transition source, intermediate point, and transition destination during refocus processing and when sound generation time periods are different.

Referring to FIG. 10A, a sensed image 1001 includes objects 1003 to 1005, and is captured while the object 1003 of the objects 1003 to 1005 is in focus.

In a frame 1002, the positional relationship of the objects 1003 to 1005 with respect to the width direction of the sensed image 1001, and in-focus depths for the objects 1003 to 1005 are shown. In FIG. 10A, an in-focus depth for the object 1003 is dx, that for the object 1004 is dm, and that for the object 1005 is do (dx<dm<do).

Also, in FIG. 10A, sounds are generated respectively from the object 1003 during a period from time t0 to time t1, from the object 1004 during a period from time t0 to time t2, and from the object 1005 during a period from time t1 to time t2. The sounds respectively from the objects 1003 to 1005 are respectively obtained by the aforementioned sound source separation as a sound (separated sound) 1006 from the object 1003 as a sound source, a sound (separated sound) 1007 from the object 1004 as a sound source, and a sound (separated sound) 1008 from the object 1005 as a sound source.

As shown in FIG. 10B, a sensed image 1009 including the in-focus object 1003 is displayed during a period from time t0 to time t01. Then, during a period from time t01 to time t02, refocus images in which an in-focus target changes in an order of the objects 1004 and 1005 are generated and displayed.

Refocus images 1010 to 1013 are those generated during the period from time t01 to time t02, and are displayed every time they are generated. The refocus image 1010 has an in-focus depth between that for the object 1003 and that for the object 1004, and does not include any in-focus object. The refocus image 1011 has the in-focus depth for the object 1004, and includes the in-focus object 1004. The refocus image 1012 has an in-focus depth between that for the object 1004 and that for the object 1005, and does not include any in-focus object. The refocus image 1013 has the in-focus depth for the object 1005, and includes the in-focus object 1005.

As described above, the sensed image 1009 including the in-focus object 1003 is displayed during the period from time t0 to time t01. Therefore, a sound 1014 during the period from time t0 to time t01 in the sound 1006 from the object 1003 as a sound source is reproduced as a reproduction sound 1023 during the period from time t0 to time t01.

Also, during a display period of the refocus image 1010, a sound 1015 during the display period in the sound 1006 from the object 1003 as a sound source is set as a transition source sound candidate, and a sound 1017 during the display period in the sound 1007 from the object 1004 as a sound source is set as a transition destination sound candidate. Then, a sound 1016 obtained by synthesizing the transition source sound candidate and transition destination sound candidate by sequentially changing a volume distribution between the transition source sound candidate and transition destination sound candidate (as described in the fourth embodiment) is reproduced as the reproduction sound 1023 during the display period.

The refocus image 1011 includes the in-focus object 1004. Therefore, a sound 1018 during a display period of the refocus image 1011 in the sound 1007 from the object 1004 as a sound source is reproduced as the reproduction sound 1023 during the display period.

Also, during a display period of the refocus image 1012, a sound 1019 during the display period in the sound 1007 from the object 1004 as a sound source is set as a transition source sound candidate. In this case, a sound during the display period in the sound 1008 from the object 1005 as a sound source is to be set as a transition destination sound candidate, but no corresponding sound is registered. Then, a sound 1020 is obtained by sequentially changing a volume of the transition source sound candidate, and is reproduced as the reproduction sound 1023 during the display period.

Since the refocus image 1013 includes the in-focus object 1005, a reproduction sound during a display period (from t02 to t1) of the refocus image 1013 is a sound during the display period in the sound 1008 from the object 1005 as a sound source. However, no corresponding sound is registered. In this case, silence 1022 is reproduced as the reproduction sound 1023 during the display period.

Of course, in this embodiment as well, as in the fourth embodiment, a generated refocus image and reproduction sound may be temporarily stored in a buffer 1024, and sounds and videos accumulated in the buffer 1024 may be synchronously output, as described above.

Note that during a period from time t1 to time t2 after completion of the digital refocus processing, a sound 1021 during the period from the time t1 to time t2 in the sound 1008 from the object 1005 as a sound source is reproduced as the reproduction sound during the display period.

Note that the description of the above example has been given under the assumption that separated sound positions are immovable, and correspondence information between one depth and one separated sound is used. However, in practice, correspondence information between a separated tone and depth is described for each predetermined time period, and reproduction processing is executed using that correspondence information between for each predetermined time period, thus coping with a case in which sounds are moved.

### Sixth Embodiment

This embodiment will explain synthesis of a reproduction sound when a refocus image simultaneously includes a plurality of in-focus regions.

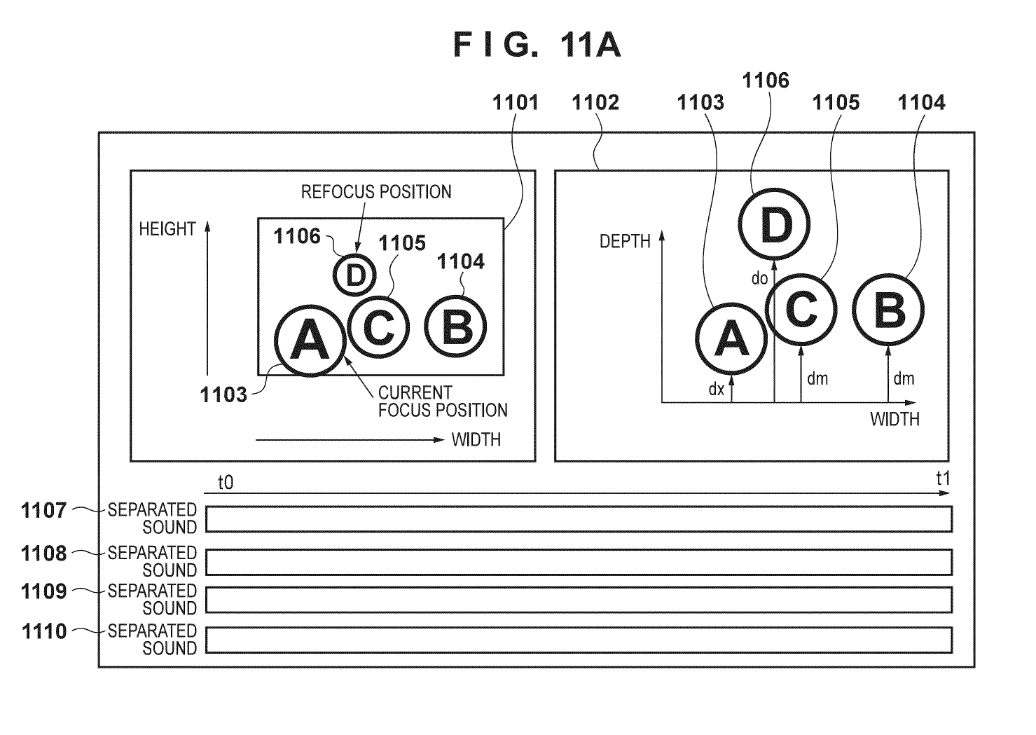

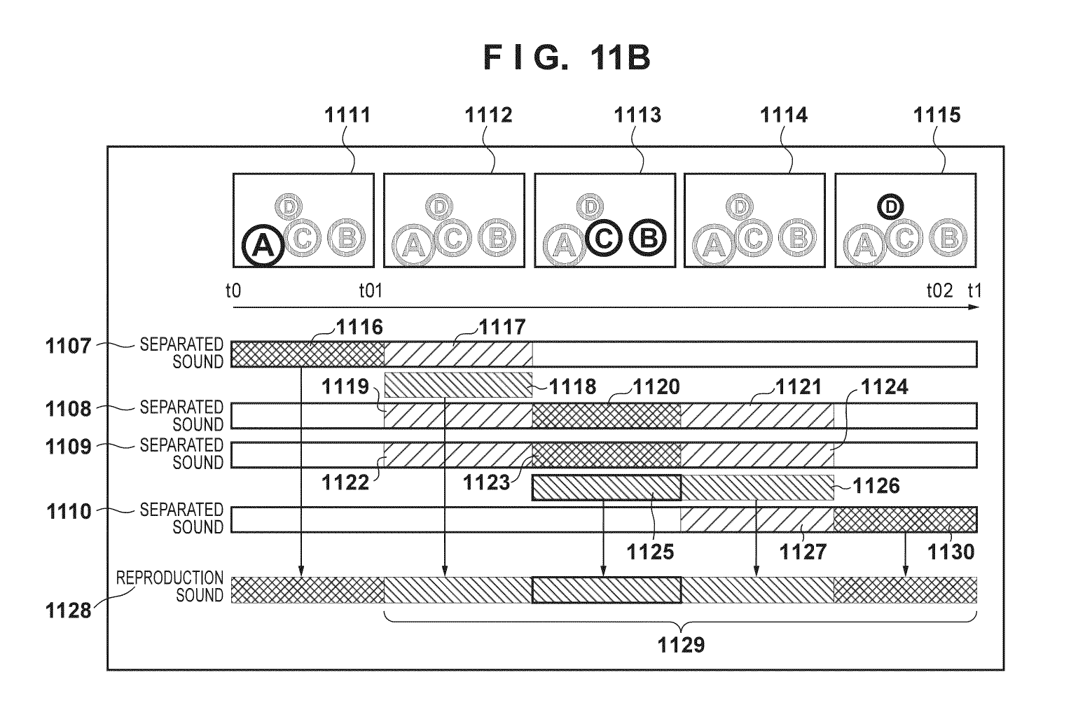

Referring to FIG. 11A, a sensed image 1101 includes objects 1103 to 1106, and is captured while the object 1103 of the objects 1103 to 1106 is in focus.

In a frame 1102, the positional relationship of the objects 1103 to 1106 with respect to the width direction of the sensed image 1101, and in-focus depths for the objects 1103 to 1106 are shown. In FIG. 11A, an in-focus depth for the object 1103 is dx, that for the objects 1104 and 1105 is dm, and that for the object 1106 is do (dx<dm<do).

Also, in FIG. 11A, sounds are generated respectively from the objects 1103 to 1106 during a period from time t0 to time t1. The sounds respectively from the objects 1103 to 1106 are respectively obtained by the aforementioned sound source separation. That is, these sounds are respectively obtained as a sound (separated sound) 1107 from the object 1103 as a sound source, a sound (separated sound) 1108 from the object 1104 as a sound source, a sound (separated sound) 1109 from the object 1105 as a sound source, and a sound (separated sound) 1110 from the object 1106 as a sound source.

As shown in FIG. 11B, a sensed image 1111 including the in-focus object 1103 is displayed during a period from time t0 to time t01. Then, during a period from time t01 to time t02, refocus images in which an in-focus target changes in an order of the objects 1104 to 1106 are generated, and the respective refocus images are displayed during a period from time t01 to time t1.

Refocus images 1112 to 1115 are those generated during the period from time t01 to time t02, and are displayed during the period from time t01 to time t1. The refocus images 1112 and 1114 do not include any in-focus objects. The refocus image 1113 has the in-focus depth for the objects 1104 and 1105, and includes the in-focus objects 1104 and 1105. The refocus image 1115 has the in-focus depth for the object 1106, and includes the in-focus object 1106.

As described above, the sensed image 1111 including the in-focus object 1103 is displayed during the period from time t0 to time t01. Therefore, a sound 1116 during the period from time t0 to time t01 in the sound 1107 from the object 1103 as a sound source is reproduced as a reproduction sound 1128 during the period from time t0 to time t01.

During a display period of the refocus image 1112, a sound 1117 during the display period in the sound 1107 is set as a transition source sound candidate, and sounds 1119 and 1122 during the display period in the sounds 1108 and 1109 are set as transition destination sound candidates. Then, a sound 1118 obtained by synthesizing the transition source sound candidate and transition destination sound candidates by sequentially changing a volume distribution between the transition source sound candidate and transition destination sound candidates (the volumes of the transition source sound candidate and transition destination sound candidates become smaller/larger as the elapse of a time) is reproduced as the reproduction sound 1128 during the display period.

The refocus image 1113 includes the in-focus objects 1104 and 1105. Therefore, during a display period of the refocus image 1113, a sound 1125 obtained by synthesizing sounds 1120 and 1123 during the display period in the sounds 1108 and 1109 is reproduced as the reproduction sound 1128 during the display period.

Also, during a display period of the refocus image 1114, sounds 1121 and 1124 during the display period in the sounds 1108 and 1109 are set as transition source sound candidates, and a sound 1127 during the display period in the sound 1110 is set as a transition destination sound candidate. Then, a sound 1126 obtained by synthesizing the transition source sound candidates and transition destination sound candidate by sequentially changing a volume distribution between the transition source sound candidates and transition destination sound candidate (the volumes of the transition source sound candidates and transition destination sound candidate become smaller/larger as the elapse of a time) is reproduced as the reproduction sound 1128 during the display period.

The refocus image 1115 includes the in-focus object 1106. Therefore, during a display period of the refocus image 1115, a sound 1130 during the display period in the sound 1110 from the object 1106 as a sound source is reproduced as the reproduction sound 1128 during the display period.

Of course, in this embodiment as well, as in the fourth embodiment, a generated refocus image and reproduction sound may be temporarily stored in a buffer 1129, and sounds and videos accumulated in the buffer 1129 may be synchronously output, as described above.

Note that in order to enhance the presence when an image simultaneously includes a plurality of in-focus regions, position information of each in-focus region may be appended to correspondence information with a separated sound. In a display time zone of the refocus image 1114 in FIGS. 11A and 11B, a sound is reproduced by synthesizing the sounds 1121 and 1124 as the transition source sound candidates and the sound 1127 as the transition destination sound candidate.

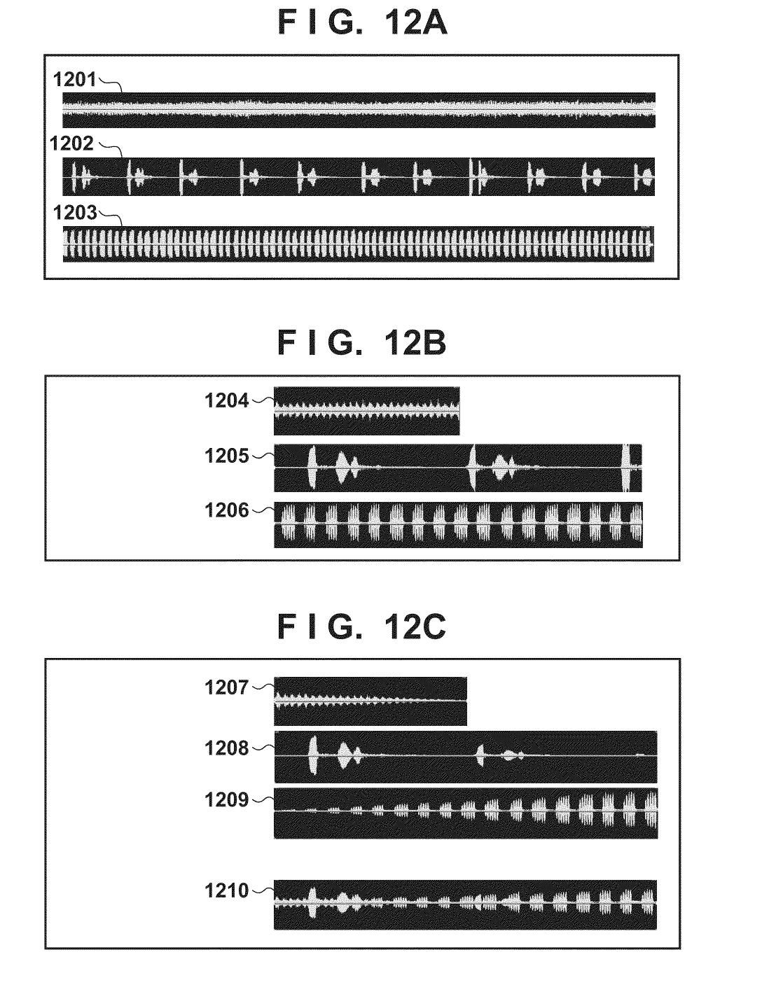

Upon transition from this state to a display state of the refocus image 1115, when the volumes of the sounds 1121 and 1124 are uniformly changed step by step, such changes create the impression that the distance to the object 1106 is the same as those of the objects 1104 and 1105. The distance as a width to the object 1104 is larger than that of the object 1105. Using position information of in-focus regions, sounds may be synthesized to shorten a time period, in which a sound is adapted as a sound candidate, in inverse proportion to a distance, so that a sound of a farther object is attenuated earlier. FIGS. 12A to 12C show such example.

In FIG. 12A, a sound waveform 1201 is that of the sound 1108, a sound waveform 1202 is that of the sound 1109, and a sound waveform 1203 is that of the sound 1110. In FIG. 12B, a sound waveform 1204 is that of the sound 1121, a sound waveform 1205 is that of the sound 1124, and a sound waveform 1206 is that of the sound 1127. However, the sound waveform 1204 is shorter than a change time period of the sound 1121. Since the position of the object 1104 is farther than the object 1105 in the width direction, the sound waveform 1204 is set to be shorter than the time period of the sound waveform 1205.

In FIG. 12C, the volumes of sound waveforms 1207 and 1208 are gradually reduced as transition source sound candidates, and that of a sound waveform 1209 is gradually raised as a transition destination sound candidate. A sound waveform 1210 obtained by synthesizing the sound waveforms 1207, 1208, and 1209 is used as a reproduction sound during the display time zone of the refocus image 1114. Since the step-by-step volume distribution change time period of the sound waveform 1207 is shorter than that of the sound waveform 1208, the sound of the sound waveform 1207 is muted earlier in the sound waveform 1210.

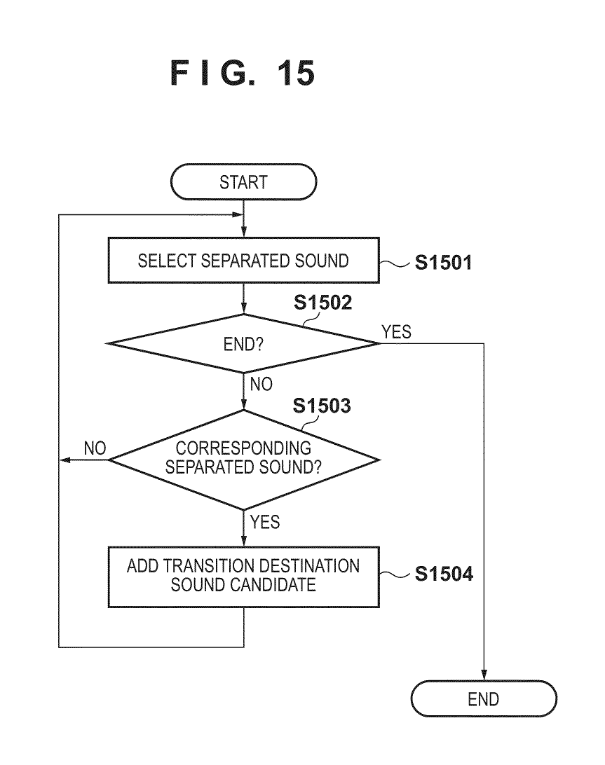

In the above embodiment, the processes of steps S709 and S710 of the flowchart in FIG. 7 are executed under the assumption that one separated sound corresponds to one in-focus depth dx. However, a case, in which a plurality of separated sounds correspond to one in-focus depth dx (for example, an image includes a plurality of objects as sound sources), can be coped with by executing the processing according to the flowchart of FIG. 15 in place of the processes of steps S709 and S710.

In step S1501, a refocus sound synthesis unit 603 selects a separated sound to be selected of a plurality of separated sounds corresponding to the in-focus depth dx from a correspondence input unit 605. In this case, if no separated sound to be selected remains, and a separated sound cannot be selected in step S1501, the process ends via step S1502. On the other hand, if a separated sound can be selected in step S1501, the process advances to step S1503 via step S1502.

The refocus sound synthesis unit 603 judges in step S1503 whether or not the separated sound selected in step S1501 corresponds to coordinates of the current object of interest (image coordinates) on an image. For example, when an image includes one object, the refocus sound synthesis unit 603 judges whether or not the selected separated sound corresponds to image coordinates of that object. On the other hand, when an image includes a plurality of objects, the refocus sound synthesis unit 603 selects one of these objects as an object of interest, and judges whether or not the selected separated sound corresponds to image coordinates of the object of interest. Therefore, when an image includes a plurality of objects, the flowchart of FIG. 15 is repeated in correspondence with the number of objects.

If the refocus sound synthesis unit 603 judges in step S1503 that the selected separated sound corresponds to image coordinates of the object of interest, the process advances to step S1504; otherwise, the process returns to step S1501. In step S1504, the refocus sound synthesis unit 603 sets the separated sound selected in step S1501 as a sound of a transition source sound candidate.

Note that in the above embodiment, when an image includes an in-focus region but does not include any corresponding separated sound, a sound is compensated for using neighboring separated sounds. However, when an in-focus object does not generate any sound, silence may be inserted. In this case, correspondence information of a depth and separated sound describes three types, that is, a depth, in-focus position, and separated sound. Even when it is determined in step S403 in the flowchart of FIG. 4 that no sound source is separated, the process advances to step S404 to associate a depth and in-focus position with each other without any separated sound. After NO is determined in step S709 in the flowchart of FIG. 7, it is judged whether or not an in-focus position corresponding to a depth is stored. If an in-focus position is stored, silence is set as a transition destination sound candidate to generate a sound. During a display period of a video which includes an in-focus region but does not include any separated sound, silence is generated.

In the above embodiment, identity of a separated sound and in-focus region is judged based on a position and depth. Alternatively, a sound recognition unit which recognizes a type of sound, and an image recognition unit which recognizes a type of object may be added, and correct correspondence information may be stored using a recognition result collation unit which judges whether or not a correspondence between the sound recognition result and image recognition result falls within an allowable range. For example, when a sound recognition result is “cuckoo” and an object recognition result is “bird”, and only when correspondence between “cuckoo” and “bird” is registered in advance, correspondence information is stored.

A sound, which cannot be localized due to its widespread location as a result of sound separation, may be associated with all videos as a background sound in place of a refocus image, and the volume of the background sound may be raised during presentation of an out-of-focus video.

The above embodiment has described a moving image and sounds which are synchronized with the moving image. Alternatively, for still images and sounds which are redundantly recorded during a still image sensing time period, a temporal transition of still images as a result of digital refocus processing may be handled as a moving image, and a reproduction sound may be generated in synchronism with that image. Note that some or all of the above embodiments may be combined and used as needed.

The above embodiments have explained sounds to be reproduced in various cases. However, cases other than those described above may occur, and sounds to be reproduced in such cases may be determined as needed. That is, already obtained sounds may be adjusted and reproduced, a synthetic sound of some sounds may be reproduced, or silence may be inserted.

That is, in the sound reproduction, the following processing is executed. Initially, from a plurality of images acquired by capturing images from a plurality of viewpoints, a first image having a region at a first in-focus depth and a second image having a region at a second in-focus depth which is different from the first in-focus depth are generated (image generation). In this image generation, a third image having a region at an in-focus depth between the first and second in-focus depths is generated. Then, the first, second, and third images are displayed on a display unit (display control). In this case, a sound for the third image is generated from those associated with the first and second images (sound generation), and the generated sound is reproduced.

In the above registration processing, the following processing is executed. Initially, from a plurality of images acquired by capturing images from a plurality of viewpoints, a plurality of images having regions at different in-focus depths are generated (image generation). Then, sounds collected using a plurality of sound collecting units are separated, sound source positions of respective separated sounds are calculated, and a position of an in-focus object in each of the generated images and a sound of the sound source position related to that position are registered in a holding unit in association with each other.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2012-212966 filed Sep. 26, 2012 and No. 2013-138442 filed Jul. 1, 2013 which are hereby incorporated by reference herein in their entirety.

What is claimed is:

1. An information processing apparatus comprising:
an image generation unit configured to generate, from a plurality of images acquired by capturing images from a plurality of viewpoints, a first image having a region at a first in-focus depth, a second image having a region at a second in-focus depth, which is different from the first in-focus depth, and a third image having a region at an in-focus depth between the first in-focus depth and the second in-focus depth;
a display control unit configured to display the first image, the third image, and the second image on a display unit;
a sound generation unit configured to generate a sound from a sound associated with the first image and a sound associated with the second image; and
a reproduction unit configured to reproduce the sound generated by said sound generation unit,
wherein said reproduction unit reproduces the sound generated by said sound generation unit while the first image, the third image, and the second image are displayed on the display unit one by one.

2. The apparatus according to claim 1, wherein the sound associated with the first image is a sound related to a position of an object at the first in-focus depth, and the sound associated with the second image is a sound related to a position of an object at the second in-focus depth.

3. The apparatus according to claim 1, wherein each of the sound associated with the first image and the sound associated with the second image is a sound obtained by separating sounds collected using a plurality of sound collecting units.

4. The apparatus according to claim 1, wherein said sound generation unit generates the sound by adjusting a volume of the sound associated with the first image and a volume of the sound associated with the second image.

5. An information processing apparatus comprising:
an image generation unit configured to generate a plurality of images having regions at different in-focus depths from a plurality of images acquired by capturing images from a plurality of viewpoints;
a separation unit configured to separate sounds collected using a plurality of sound collecting units, and to calculate sound source positions of respective separated sounds; and
a registration unit configured to register, for each of the images generated by said image generation unit, a position of an object at the in-focus depth in that image and a sound of a sound source position related to that position in a holding unit in association with each other.

6. The apparatus according to claim 5, wherein said registration unit registers a position of an object at an in-focus depth in each image generated by said image generation unit and a sound at the same position as that position in the holding unit in association with each other.

7. The apparatus according to claim 5, wherein said registration unit registers a position of an object at an in-focus depth in each image generated by said image generation unit and a sound at a position which is the same as or adjacent to that position in the holding unit in association with each other.

8. An information processing method executed by an information processing apparatus, comprising:
an image generation step of generating, from a plurality of images acquired by capturing images from a plurality of viewpoints, a first image having a region at a first in-focus depth, a second image having a region at a second in-focus depth, which is different from the first in-focus depth, and a third image having a region at an in-focus depth between the first in-focus depth and the second in-focus depth;
a display control step of displaying the first image, the third image, and the second image on a display unit;
a sound generation step of generating a sound from a sound associated with the first image and a sound associated with the second image; and
a reproduction step of reproducing the sound generated in the sound generation step,
wherein in the reproduction step, the sound generated in the sound generation step is reproduced while the first image, the third image, and the second image are displayed on the display unit one by one.

9. The method according to claim 8, wherein the sound associated with the first image is a sound related to a position of an object at the first in-focus depth, and the sound associated with the second image is a sound related to a position of an object at the second in-focus depth.

10. The method according to claim 8, wherein each of the sound associated with the first image and the sound associated with the second image is a sound obtained by separating sounds collected using a plurality of sound collecting units.

11. The method according to claim 8, wherein in the sound generation step, the sound is generated by adjusting a volume of the sound associated with the first image and a volume of the sound associated with the second image.

12. An information processing method executed by an information processing apparatus, comprising:
an image generation step of generating a plurality of images having regions at different in-focus depths from a plurality of images acquired by capturing images from a plurality of viewpoints;
a separation step of separating sounds collected using a plurality of sound collecting units, and of calculating sound source positions of respective separated sounds; and
a registration step of registering, for each of the images generated in the image generation step, a position of an object at the in-focus depth in that image and a sound of a sound source position related to that position in a holding unit in association with each other.

13. The method according to claim 12, wherein in the registration step, a position of an object at an in-focus depth in each image generated in the image generation step and a sound at the same position as that position are registered in the holding unit in association with each other.

14. The method according to claim 12, wherein in the registration step, a position of an object at an in-focus depth in each image generated in the image generation step and a sound at a position which is the same as or adjacent to that position are registered in the holding unit in association with each other.

15. A non-transitory computer-readable storage medium storing a computer program for controlling a computer to function as respective units of an information processing apparatus according to claim 1.
